(19) United States
(12) Patent Application Publication
(10) Pub. No.: US 2023/0278247 A1
(43) Pub. Date: Sep. 7, 2023

(54) FIXED BLADE KNIFE SHEATH ASSEMBLY

(71) Applicant: Andrew Demko, Wampum, PA (US)

(72) Inventor: Andrew Demko, Wampum, PA (US)

(21) Appl. No.: 17/688,161

(22) Filed: Mar. 7, 2022

(51) Int. Cl. B26B 29/02

(52) U.S. Cl. CPC B26B 29/025

(57) ABSTRACT

A knife sheath assembly having a knife blade receiving opening chamber with a knife handle engagement stopper. A pair of rigid sheath shells are secured together by edge shell engagement fittings. Each sheath shell defines a contoured recess knife receiving portion that encloses the knife blade when assembled. The sheath shells are formed of non-abrasive synthetic material to safely engage and hold the knife blade without insertion or retrieval damage thereto.

### BACKGROUND OF THE INVENTION

### 1. Technical Field

The present invention relates to knife sheaths, more specifically hard-shell knife receiving sheaths.

### 2. Description of Prior Art

Prior art knife sheaths have been developed to support and protect blade affixed handle knifes, see for example U.S. Pat. Nos. 3,363,813, 7,434,316, 9,254,577, 10,456,938 and U.S. Publications 2007/0266569, 2013/0026054 and International Publication WO 2020245684.

In U.S. Pat. No. 3,363,813 a knife scabbard is disclosed having a leather front and back with a pair of support elements there between.

U.S. Pat. No. 7,434,316 is directed to a fixed knife and knife sheath wherein the sheath has front and back members with a spring biased element that rotates to secure the knife within.

U.S. Pat. No. 9,254,577 discloses a knife and sheath assembly with a repositional knife strap which is stretchable.

U.S. Pat. No. 10,456,938 claims a sheath and knife separation control structure. A first and second sheath shell are secured together with a movable stop block to secure the knife within the sheath.

U.S. Publication 2007/0266569 discloses a fixed knife and knife sheath with a spring member on the knife that selectively engages a catch on the sheath adjusting its opening.

U.S. Publication 2013/0026054 shows a knife sheath formed with a plurality of gaps along its side to allow debris from collecting within the sheath and engage the blade.

International Publication WO 2020245684 illustrates a knife sheath having a rigid body secured together by a perimeter fastener defining a knife receiving cavity.

### SUMMARY OF THE INVENTION

A knife sheath for safe insertion retrieval and selective retainment of a fixed blade knife without excess wear or damage on the sharpened blade. The knife sheath of the invention has a pair of rigid shells secured together by edge retainment fittings in isolated 15 orientation of the knife blade there within. Multiple fasteners secure the retainment fittings to the respective shells. A knife handle engagement stopper is formed by the interengaging contoured shell end portions.

### DESCRIPTION OF THE DRAWINGS

FIG. 1 is a perspective view of the knife sheath and a fixed blade knife positioned for insertion therein.

FIG. 2 is an enlarged exploded perspective view of the knife sheath of the invention.

FIG. 3 is an enlarged sectional view on lines 3-3 of FIG. 2.

FIG. 4 is an enlarged top plan view of a retainment fitting of the knife sheath.

FIG. 5 is an enlarged side elevational view thereof on lines 5-5 of FIG. 4.

FIG. 6 is an end elevational view on lines 6-6 of FIG. 1.

FIG. 7 is an end elevational view on lines 7-7 of FIG. 1.

FIG. 8 is a top plan view with portions broken away showing the knife sheath with a knife positioned therein.

FIG. 9 is an enlarged perspective view of an alternate retainment fitting.

### DETAILED DESCRIPTION OF THE INVENTION

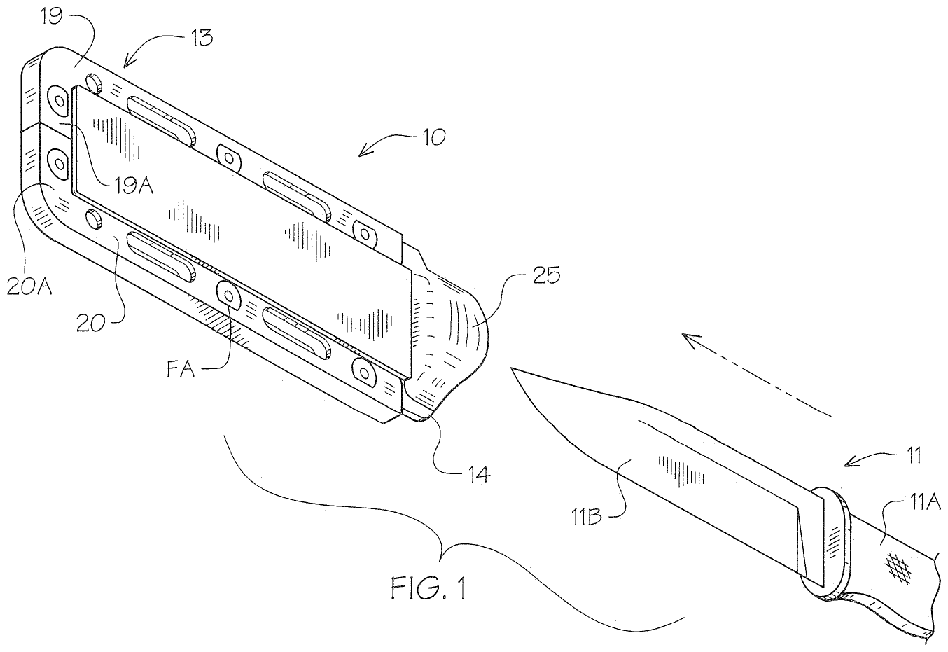

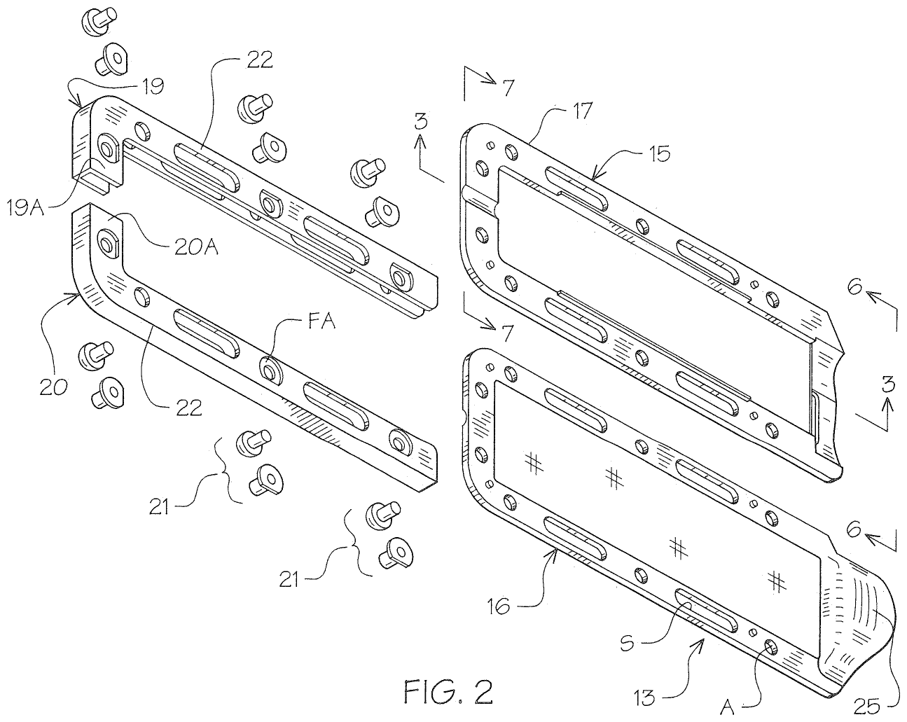

Referring to FIGS. 1 and 2 of the drawings, a knife sheath 10 of the invention can be seen with a fixed blade knife 11 positioned for selective insertion therein. The knife 11 has a handle portion 11A and a fixed blade 11B extending therefrom. The knife sheath 10 is an assembly of a first rigid shell 12 and a second rigid shell 13, best seen in FIG. 2 of the drawings. Each of the sheath shells are of a rectangular configuration with a perimeter flat extending flange 14 defining oppositely disposed spaced parallel sides 15 and 16 and integral interconnecting respective flange ends 17.

Central recess areas 12A and 13A respectively define a blade receiving chamber 18 when secured together, as seen in FIG. 1 of the drawings. The parallel flange sides 15 and 16 and flange ends 17 have a plurality of apertures A therein for fastener insertion as will be described in detail hereinafter. A pair of longitudinally spaced slots S are formed within each of the flange sides 15 and 16 between the respective apertures A.

A pair of edge flange engagement fittings 19 and 20 are engageable over the respective flange sides 15 and 16 and ends 17. Each of the flange engagement fittings 19 and 20 has a cross-sectionally U-shaped elongated body member with respective right angled end portions 19A and 20A. The flange engagement fittings 19 and 20 have a plurality of vertically aligned fastener receiving apertured pairs FA in longitudinally spaced relation to one another, as seen in FIG. 2 of the drawings. The respective apertured pairs FA are configured to accept threaded male and female fastener fittings 21 as are well known within the art.

Each of the engagement fittings 19 and 20 have pairs of vertical aligned slots 21 which are positioned for alignment with corresponding slot pairs 22 in the respective flange sides 15 and 16 between the corresponding apertures A as hereinbefore described.

It will be evident from the above description that the flange engagement fittings 19 and 20 are slidably disposed over the flange edge pairs 15, 16 and 17 of the first and second shells 12 and 13 when engaged with one another and secured together by fastener fittings 21 to form the assembled knife sheath 10 of the invention as seen in FIG. 1 of the drawings.

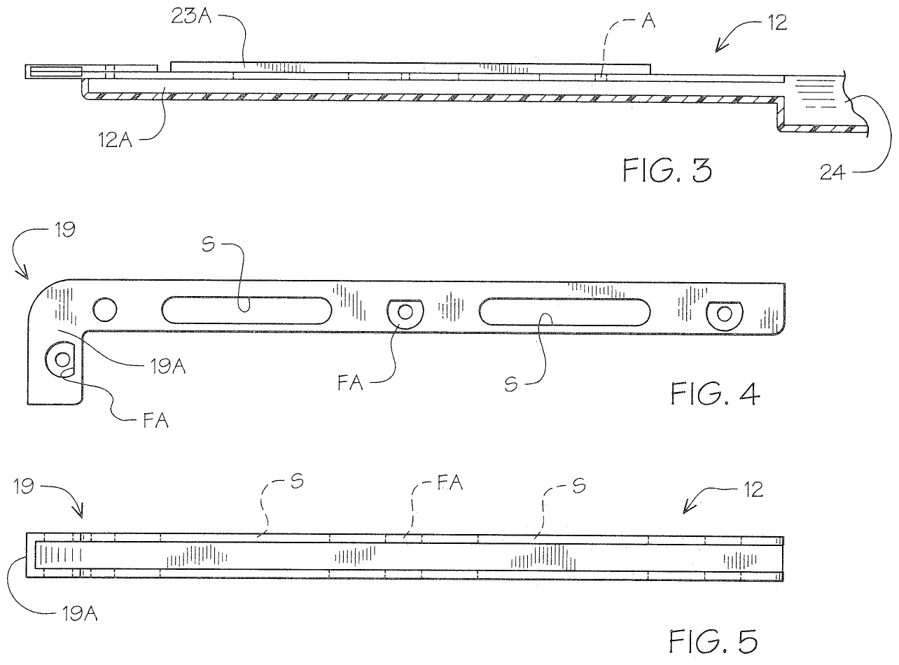

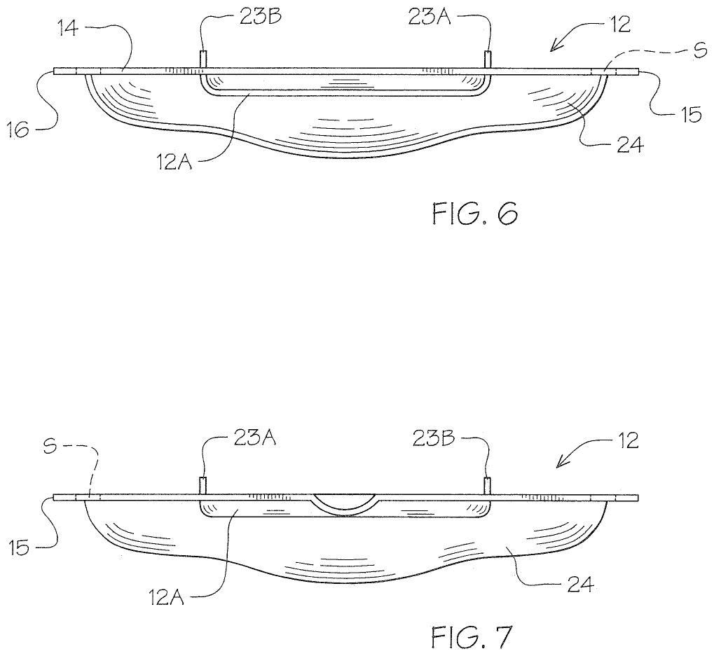

Referring now to FIG. 3 of the drawings, a side elevational sectional view of the first shell 12 can be seen illustrating the depth of the respective recess area 12A. A pair of upstanding shell registration flanges 23A and 23B extend from edges of the recess area 12A and are registerably engaged within the oppositely disposed recess area 13A of the shell 13. This provides for transverse positional orientation of the respective shells 12 and 13 together during assembly and the continuity of the blade receiving chambers upper and lower blade engagement longitudinal interior surfaces for the blade's 11B respective edges 11C and 11D, as seen in FIG. 8 of the drawings. Each of the first and second shells 12 and 13 has a contoured upstanding handle end engagement portion 24 and 25 extending from the respective recess areas 12A and 13A which when secured together form a handle retainment and stop for insertion of the fixed knife 11 as seen in FIG. 6 of the drawings. It will be seen that upon assembly, the rigid knife sheath 10 of the invention that the respective end fittings 19 and 20 end angle portions 19A and 20A abut one another enclosing and secure the corresponding shell end flange portions 17.

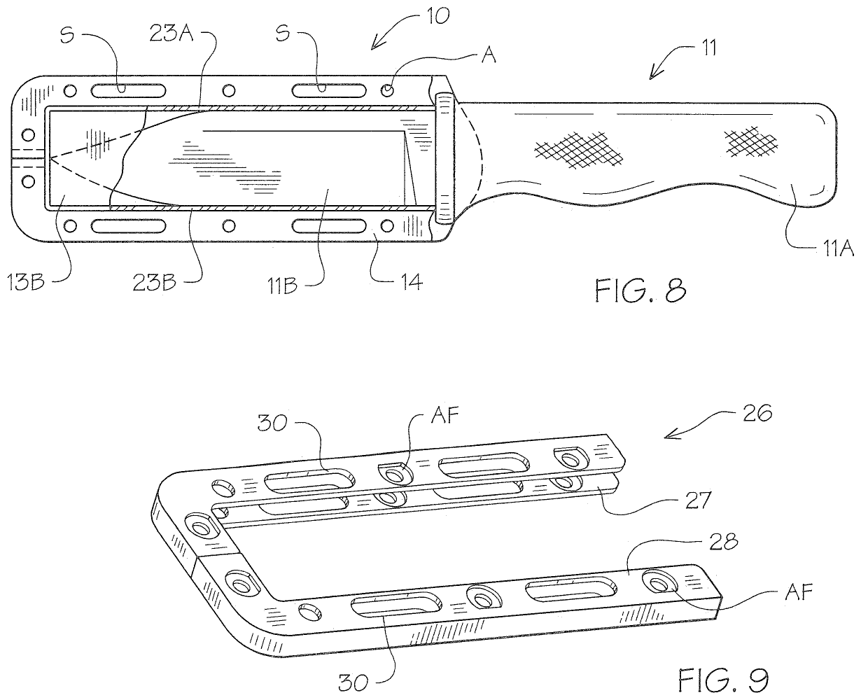

Referring now to FIG. 9 of the drawings, an alternate form of the invention can be seen wherein a one-piece flange engagement fitting 26 is illustrated having integral continuous U-shaped channel configuration with oppositely disposed spaced parallel side flange engagement channel openings 27 and 28 and an integral continuous end channel opening 29. The flange engagement fitting 26 has identical aligned aperture pairs AF and slots 30 as illustrated and described in the hereinbefore primary form of the invention for the selective receiving and containment of fastener fittings 21 thus securing the continuous flange engagement 26 over a pair of oppositely disposed engaged first and second shells 12 and 13 thus defining a completed hard shell sheath configuration.

It will thus be seen that a new and novel rigid fixed blade knife receiving sheath 10 and 29 of the invention has been illustrated and described therein. Therefore I claim:

1. A sheath for a fixed blade knife comprises,
a first and second rigid shell defining a knife receiving chamber of the sheath and a handle receiving stop portion,
an engagement flange extending about said respective shells,
a flange engagement fitting registerably secured to said engagement flanges when in registered engagement with one another,
a plurality of fastener fittings extending through aligned apertures in said respective flange engagement fittings and said shell engagement flanges.

2. The sheath for a fixed blade knife set forth in claim 1 wherein said knife receiving chamber comprises, a first and second central recessed areas within said respective rigid shells.

3. A sheath for a fixed blade knife set forth in claim 1 wherein said handle receiving and stop portion of said sheath comprises,
a contoured handle end engagement portion on each of said shells extending from said corresponding central recessed areas opposite end flange portions.

4. The sheath for a fixed blade knife set forth in claim 1 wherein said shell flange engagement fitting comprises,
an elongated U-shaped channel having a plurality of longitudinally spaced vertically aligned paired apertures therein.

5. The sheath for a fixed blade knife set forth in claim 1 wherein said flange engagement fittings have a right-angle extending end portion for abutting engagement on and end portion shell flange.

6. The sheath for a fixed blade knife set forth in claim 2 wherein one of said central recess areas of said shell further comprises,
a pair of parallel spaced upstanding shell engagement alignment flanges defining blade edge engagement surfaces.
